(19) United States
(12) Patent Application Publication
(10) Pub. No.: US 2012/0164260 A1
(43) Pub. Date: Jun. 28, 2012

(54) PIPE PROCESSING APPARATUS

(76) Inventor: Oscar McAven, Braak (DE)

(21) Appl. No.: 13/329,026

(22) Filed: Dec. 16, 2011

(30) Foreign Application Priority Data
Dec. 27, 2010 (DE) 102010056449.4

(51) Int. Cl. B29C 59/02

(52) U.S. Cl. 425/385

(57) ABSTRACT

Pipe processing apparatus comprising a stamping tool for applying peripheral embossing and/or peripheral stamping to a pipe end section of a pipe, characterised in that the pipe processing apparatus comprises a template which has a pipe sleeve which can be inserted in the pipe end section and having at least one contact surface region, wherein the contact surface region is designed and equipped to limit the insertion depth of the pipe sleeve by means of positive locking between the contact surface region and at least one part region of a pipe end of the pipe end section facing the contact surface region and to position the stamping tool in a work position on the pipe end section as a stamping tool counter-surface.

### CROSS-REFERENCE TO RELATED APPLICATIONS

This application claims the benefit of German Patent Application No. 10 2010 056 449.4, filed on Dec. 27, 2010, entitled “A PIPE PROCESSING APPARATUS”, the entire contents of which are incorporated herein by reference.

### BACKGROUND OF THE INVENTION

1. The Field of the Invention

The present invention relates to a pipe processing apparatus comprising a stamping tool for applying peripheral embossing and/or periphery stamping to a pipe end section of a pipe.

Such apparatuses are used in particular for processing ventilation pipes. It is known to connect ventilation pipes to one another by pushing one into another. Hence, the pipe section of a pipe is inserted into the corresponding other pipe and secured against unintentional release. Securing of the connection of both pipes may be effected by means of self-tapping screws, rivets or the like. Furthermore, it is known to secure the connection of the pipes against unintentional release of the connection by means of locking means arranged on the corresponding pipe end sections. Peripheral embossing and/or peripheral stamping is arranged on the pipe wall of the corresponding outer pipe end section. This locking means engages with further locking means arranged on the inserted pipe and thus stop or lock the two pipes automatically with one another during insertion one into another. Peripheral embossing and/or peripheral stamping is usually applied to the pipe end section of the corresponding outer pipe with a corresponding stamping tool, in that the stamping tool, for example embossing tongs and/or stamping tongs, is introduced into the pipe end section and the pipe wall of the pipe end section is embossed and/or stamped out at the required positions. In order to guarantee reliable securing of the pipe connection and to secure it against unintentional release of the connection, it is necessary to apply to the pipe wall all peripheral embossing and/or peripheral stamping exactly with respect to a plane aligned vertically to the pipe longitudinal axis.

2. The Relevant Technology

A tool and a method for connecting pipelines is known from document U.S. Pat. No. 7,013,699 B1. The tool has a clamping jaw with a stamp which can be adjusted by means of an Allen key. Corresponding depressions may be embossed in the pipe wall by means of the stamp. The other clamping jaw has a V-shaped depression which serves as a counter-surface to the stamp tip.

Document JP 2002-153 919 A shows a shaping tool and a production method for cylindrical products, wherein the outer wall of a blank is provided with stamping from three directions at the same time.

The disadvantage is that using the known apparatuses, precise positioning of the peripheral embossing and/or peripheral stamping may be guaranteed only when the pipe edge is aligned correspondingly flatly and vertically with respect to the longitudinal axis of the pipe, since usually the pipe end itself serves as a reference for positioning of the stamping tool. If the pipe edge is not sufficiently flat and/or the plane spanned by the pipe end is not exactly vertical to the longitudinal axis, peripheral embossing and/or peripheral stamping is not applied to the pipe wall at the required positions, namely preferably exactly on a plane running vertically to the longitudinal axis of the pipe. This results in reliable locking of the pipe sections not being able to be guaranteed. In order nevertheless to achieve a reliable connection of the pipe sections, it is therefore necessary to provide pipes, the pipe ends of which are aligned on the one hand exactly flatly and on the other hand precisely vertically to the longitudinal axis of the pipe. This usually requires special processing apparatuses, for example specially equipped separating tables, on which the pipe is clamped to then subsequently be separated by means of a precision cut or to be levelled at the pipe end. On the one side, such processing apparatuses require considerable space, which often is unavailable or only available to a restricted extent for installation work, such as for example the installation of ventilation pipes. On the other hand, such processing is expensive and time-consuming, since several processing steps are necessary before the pipe ends may be provided with the corresponding peripheral embossing and/or peripheral stamping.

### BRIEF SUMMARY OF THE INVENTION

These and other objects and features of the present invention will become more fully apparent from the following description and appended claims, or may be learned by the practice of the invention as set forth hereinafter.

It is therefore the object of the present invention to propose a pipe processing apparatus which is simple to manage and compact and which facilitates exact application of peripheral embossing and/or peripheral stamping to a pipe.

The object is achieved by an arrangement having the features mentioned in the introduction in that the pipe processing apparatus comprises a template which has a pipe sleeve which can be inserted in the pipe end section and having at least one contact surface region, wherein the contact surface region is designed and equipped to limit the insertion depth of the pipe sleeve by means of positive locking between the contact surface region and at least one part region of a pipe end of the pipe end section facing the contact surface region and to position the stamping tool in a work position on the pipe end section as a stamping tool counter-surface. Hence it is possible independently of the condition of the pipe end to apply peripheral embossing and/or peripheral stamping precisely and exactly to the pipe section, even if the pipe end is not aligned vertically to a longitudinal axis of the pipe and/or has unevenness. Hence, the work effort, for example during installation of ventilation pipe systems, is considerably reduced. Since now no extensive demands are placed on the pipe ends with regard to evenness and the alignment with respect to the longitudinal axis, the pipes may be cut to the required length, for example by means of an abrasive cutter. Inevitably occurring unevenness and/or separating cuts not effected at right-angles to the longitudinal axis do not have an effect on the positional accuracy of peripheral embossing and/or peripheral stamping when using the pipe processing apparatus according to the invention. Furthermore, the tool according to the invention is extremely compact so that it is also simple to manage even in confined spatial conditions.

An expedient design of the invention is characterised in that the contact surface region is arranged to surround the pipe sleeve. In this manner, as large as possible a contact surface is provided between the contact surface region and the part region of the pipe end. Furthermore, the position of the template relative to the pipe end section is unambiguously fixed after insertion of the pipe sleeve and also may no longer lead to displacement of the template in the direction of the longitudinal axis during unintentional rotation of the template about the longitudinal axis.

A preferred development of the invention is characterised in that the contact surface region has at least one recess which is designed and equipped for positive-locking lateral reception and guiding of the stamping tool. This is particularly advantageous, since the stamping tool is aligned and exactly positioned not only in longitudinally axial direction, that is, in the direction of a longitudinal axis of a pipe, but furthermore at the same time with regard to the required position of peripheral embossing and/or peripheral stamping, is guided laterally along the pipe periphery.

A further expedient design of the invention is characterised in that the pipe sleeve has at least one longitudinally axial depression which is equipped to form a reception space between the pipe sleeve and a pipe wall of the pipe end section along at least one part section of the pipe sleeve. The longitudinally axial depression and the corresponding reception space facilitate simple removal of the template from the pipe end section after processing of the pipe wall by means of the stamping tool. Furthermore, the external diameter of the pipe sleeve may thus be selected to be as large as possible without the pipe sleeve being jammed in the pipe end section after application of peripheral embossing and/or peripheral stamping, so that the pipe sleeve can be introduced into the pipe end section with tight fit. This has the advantage that the pipe sleeve may be inserted into the pipe end section to the greatest possible extent without clearance and in this manner, possible angle errors are ruled out due to not exactly parallel alignment of the pipe sleeve with the longitudinal axis. In spite of the preferably low gap size between the pipe sleeve and the pipe end section, it is therefore always possible, due to the reception space which is adapted accordingly for reception of peripheral embossing and/or peripheral stamping, to remove the template or the pipe sleeve again from the pipe end section without jamming after processing.

According to a further preferred embodiment, the pipe sleeve has at least one recess which is equipped and arranged such that the pipe sleeve can be fitted unhindered by a stamp and/or a die of the stamping tool in the work position for application of peripheral embossing and/or peripheral stamping. In other words, the template can be fitted at the intended positions for the stamping tool or its stamp and die, so that the stamping tool can indeed be aligned and positioned by means of the template, but at the same time the function of the stamping tool on the part of the template is neither restricted nor obstructed.

A further expedient design of the invention is characterised in that the recess of the pipe sleeve, the longitudinally axial depression and the recess of the contact surface region are arranged at least essentially to be longitudinally axial to one another. This is particularly advantageous, since the pipe sleeve may be removed from the pipe end section after processing of the pipe wall by simply moving the template in the direction of the longitudinal axis.

According to a further preferred design of the invention, the pipe sleeve has several recesses and/or longitudinally axial depressions and/or recesses of the contact surface region, which are each arranged to be symmetrical with respect to a longitudinal axis of the pipe. Consequently, peripheral embossing and/or peripheral stamping is arranged correspondingly symmetrically after processing of the pipe wall, so that in its function as locking means, it may at the same time absorb any tensile forces between the pipe sections connected to one another.

A further preferred design of the invention is characterised in that the stamping tool counter-surface is designed to correspond to a contact surface of the stamping tool. This has a particularly advantageous effect on the simple manageability and the precision of positioning of the stamping tool. Due to the geometric matching of the contact surface with respect to the geometry of the stamping tool piece and vice versa, it is ensured that the stamping tool may be arranged precisely at an intended position on the pipe end section to be able to provide the pipe wall with peripheral embossing and/or peripheral stamping.

A particularly preferred design of the invention is characterised in that a spring element is arranged in at least one of the recesses. In this manner a corresponding force is exerted by means of the spring element on the regions of the pipe sleeve which lie between the recesses of the pipe sleeve, so that the pipe sleeve is held non-positively in the pipe end section. Hence, the template is stopped on the one hand securely during processing and at the same time is secured against unintentional displacement. Due to the spring effect of the spring element, the template may however be removed easily again from the pipe end section after processing.

### BRIEF DESCRIPTION OF THE DRAWINGS

Further preferred and/or expedient features and designs of the invention can be seen from the sub-claims and the description. A particularly preferred embodiment of the invention is illustrated in more detail using the attached drawing. In the drawing:

FIG. 1 shows the pipe processing device according to the invention in section,

FIG. 2 shows a perspective view of the pipe processing device shown in FIG. 1, and

FIG. 3 shows a perspective view according to a second embodiment of the pipe processing apparatus according to the invention.

### DETAILED DESCRIPTION OF THE PREFERRED EMBODIMENTS

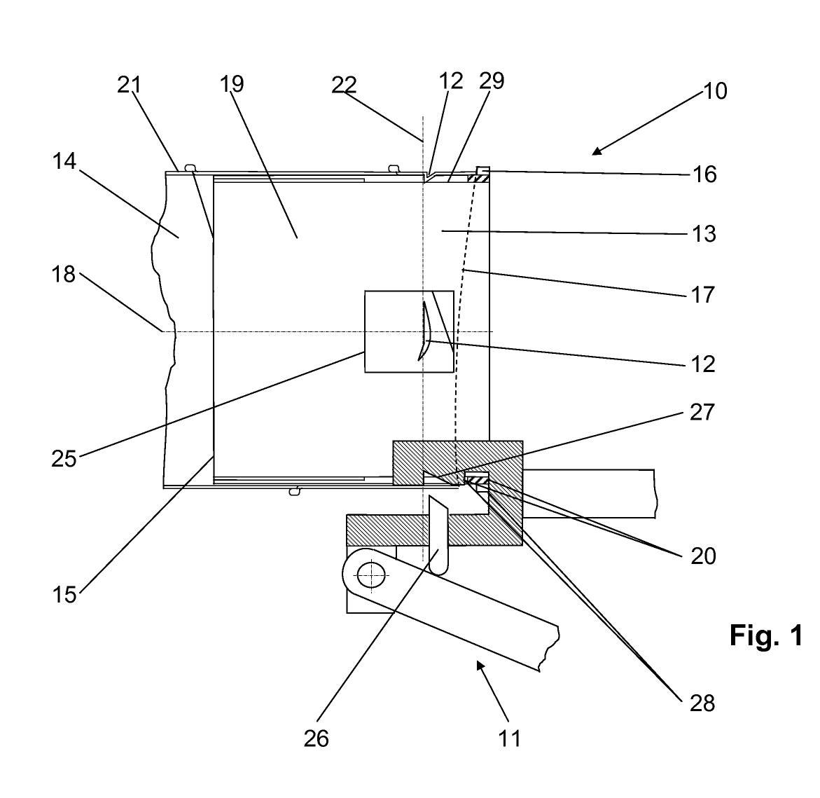

FIG. 1 shows an exemplary embodiment according to a preferred embodiment of a pipe processing apparatus of 10 according to the invention in section. The pipe processing apparatus 10 comprises a stamping tool 11 for application of peripheral embossing 12 and/or peripheral stamping 12 to a pipe end section 13 of a pipe 14. The present invention is suitable particularly for application of peripheral embossing 12 and/or peripheral stamping 12 in ventilation pipes, wherein peripheral embossing 12 and/or peripheral stamping 12 thus serves as locking means to stop a connection between the corresponding pipe section 13 and a further pipe against unintentional release. Of course the present invention is however not restricted exclusively to the processing of ventilation pipes, but is also suitable for any other type of pipe. In particular it should be pointed out that the shape of the pipe cross-section does not necessarily have to be circular, but rather any other pipe cross-sectional shape is suitable.

To simplify the following description, below reference is made exclusively to peripheral embossing 12, but the present invention should not be restricted exclusively to peripheral embossing 12, but also comprises peripheral stamping 12 or a combination of peripheral embossing 12 and/or peripheral stamping 12. The pipe processing apparatus 10 comprises a template 19 which has a pipe sleeve 15 with a contact surface region 16. The pipe sleeve 15 is designed to be insertable in the pipe end section 13, that is, its external diameter is at least less than the internal diameter of the pipe end section 13. The external diameter of the pipe sleeve 15 is preferably slightly less than the internal diameter of the pipe end section 13 such that the pipe sleeve 15 can be inserted essentially clearance-free into the pipe end section 13. If several of the pipes 14 or of the pipe end sections 13 are to be processed with in each case different diameter, accordingly in each case several pipe sleeves 15 are provided with an external diameter corresponding to the particular internal diameter of the particular pipe section 13. One end of the pipe sleeve 15 has a contact surface region 16 which is designed and equipped to limit the insertion depth of the pipe sleeve 15 in the pipe end section 13. The contact surface region 16 has an outer dimension which is greater than the internal diameter of the pipe end section 13, so that the contact surface region 16 limits the insertion depth of the pipe sleeve 15 by positive locking with at least one part region of a pipe end 17 of the pipe section 13 facing the contact surface region 16. If the pipe end 17, which is indicated in FIG. 1 by the dashed line, is not completely flat or vertical with respect to a longitudinal axis 18 of the pipe 14, there is positive locking with the pipe end 17 only in some of the part regions of the contact surface region 16. Expressed differently, the contact surface region 16 lies in a work position of the stamping tool 11 against the region of the pipe end 17 projecting the furthest. At the same time alignment of the template 19 with respect to the longitudinal axis 18 is effected by means of the pipe sleeve 15 inserted in the pipe end section 13. In other words, the template 19 with the pipe sleeve 15 and the contact surface region 16 is designed and equipped such that the template 19 can be aligned on the one hand parallel to the longitudinal axis 18 and on the other hand the insertion depth is defined exactly by partial positive locking between the contact surface region 16 and the pipe end 17. Due to the described alignment of the template 19, namely by means of the pipe sleeve 15 aligned parallel to the longitudinal axis 18 and by means of the contact surface region 16 aligned vertically to the longitudinal axis 18, the contact surface region 16 is designed and equipped as a stamping tool counter-surface 20. In other words, the contact surface region 16 serves as a contact aid and positioning aid for the stamping tool 11.

As shown in FIG. 1, the stamping tool 11 is introduced partly into the pipe section 13 in the work position and engages the pipe wall 21 of the pipe section 13 to be processed, wherein the work position of the stamping tool 11 is fixed by the stamping tool counter-surface 20 or a corresponding contact surface 28 of the stamping tool 11. The contact surface region 16 describes—independently of the external shape of the pipe end 17—a plane which is arranged vertically to the longitudinal axis 18. Consequently, the stamping tool 11 is positioned similarly in any of the work positions with respect to a reference plane 22 aligned vertically to the longitudinal axis 18.

In this manner it is possible to apply exactly several of the cases of peripheral embossing 12 along a sectional line between the pipe wall 21 and the reference plane 22. The contact surface region 16 may be designed, for example as a completely or partly circulating edge extending outwards, for example in the form of a beaded edge. Of course it is also possible that the pipe sleeve 15 and the contact surface region 16 are manufactured as a turned part. Alternatively, the contact surface region 16 is not, as shown in FIG. 1, arranged on the one end of the pipe sleeve 15, but at any position on the outer wall of the pipe sleeve 15.

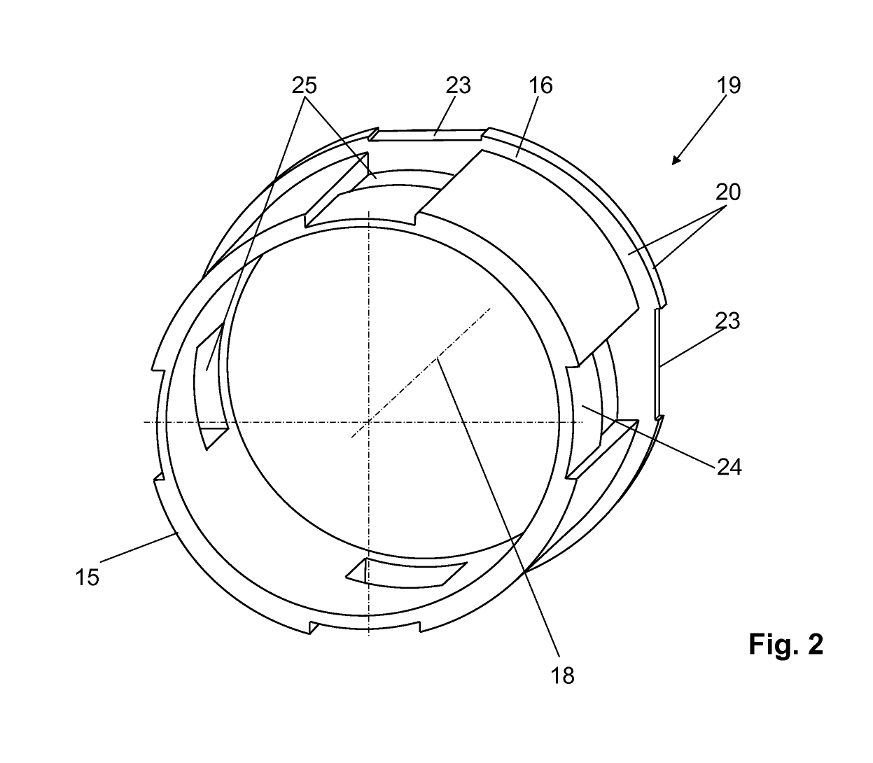

FIG. 2 shows a perspective view of the present invention. According to a preferred development of the invention, the contact surface region 16 is arranged to surround the pipe sleeve 15. The contact surface region 16 particularly preferably has one or more recesses 23. The recesses 23 are advantageously arranged to be symmetrical to the longitudinal axis 18. The recesses 23 serve for lateral guiding and reception of the stamping tool 11. The lateral guiding of the stamping tool 11 is effected by positive locking between the stamping tool 11 and the recess 23. The stamping tool 11 and the recesses 23 are consequently equipped to correspond to one another. The recess 23 preferably extends only over that part of the contact surface region 16 which is located outside of the actual pipe cross-section of the pipe 14. Alternatively, the recess 23, as shown in FIG. 2 by way of example, may extend so far in the direction of the longitudinal axis 18 that in the region of the recess 23, at least one part of the pipe end 17 is exposed.

According to a further preferred development of the invention, the pipe sleeve 15 has one or more longitudinally axial depression(s) 24, wherein longitudinally axial means that the depression is arranged at least essentially parallel to the longitudinal axis 18. The depression 24 and the pipe wall 21 form a corresponding reception space 29. The reception space 29 guarantees that the template 19 may be withdrawn unhindered from the pipe end section 13 after processing of the pipe wall 21 using the stamping tool 11. If by means of the stamping tool 11, peripheral embossing is applied to the pipe wall 21, the pipe wall 21 is deformed inwards, that is towards the longitudinal axis 18. In order to avoid jamming of the pipe sleeve 15 with the inwardly embossed peripheral embossing 12, the reception space 29 is adapted accordingly. The reception space 29 likewise fulfils the previously described function when applying peripheral stamping 12 to the pipe wall 21. When stamping out separate material parts, there is sufficient space in the reception space 29 so that the pipe sleeve 15 can be removed from the pipe end section 13 without problems after the stamping process. The depression 24 has, for example the shape of an elongated channel. However, any other cross-sectional shape of the depression 24 is also suitable which guarantees a corresponding size of the reception space 29. It is also possible that the depression 24 is not aligned longitudinally axially, but extends spirally over the periphery of the pipe sleeve 15. In this case the pipe sleeve can be removed from the pipe end section 13 after processing with the stamping tool 11 by means of a rotary/pulling movement. The longitudinally axial depression 24 preferably extends along a part region of the pipe sleeve 15.

In order to guarantee unhindered access of the stamping tool 11 to apply peripheral embossing 12 to the pipe wall 21 of the pipe sleeve 15, the pipe sleeve 15 has at least one recess 25. The recess 25 is designed and equipped to correspond to the stamping tool 11 such that the pipe sleeve 15 can be fitted unhindered by a stamp 26 or a die 27 to apply peripheral embossing 12 in the work position. The stamp 26 or the die 27 is preferably equipped such that peripheral embossing 12 or peripheral stamping corresponds to a preset pattern. Hence, it is for example possible to apply peripheral stamping 12 which is equipped as locking means to stop a pipe connection. The recess 25 is consequently arranged in the region of the pipe sleeve 15, on which after insertion of the pipe sleeve 15 in the pipe end section 13, deformation and/or stamping of the pipe wall 21 is to take place. In other words, the position of the recess 25 in conjunction with the stamping tool counter-surface 20, the contact surface 28 and the geometry of the stamping tool 11, is matched such that the stamp 26 or the die 27 in the region of the recess 25 may pass freely through the pipe sleeve 15 to process the pipe wall 21. The size of the recess 25 is preferably selected to correspond to the size of the stamp 26 or the die 27. Alternatively, the recess 25 may however also be selected to be greater than the relevant dimensions of the stamping tool 11. Hence, the recess 25 may extend at the most over the entire length of the pipe sleeve 15 so that in this case no longitudinally axial depression 24 is provided, since the recess 25 guarantees the problem-free removal of the pipe sleeve 15 after processing of the pipe wall 21 using the stamping tool 11. To retain a minimum stability of the pipe sleeve 15, it is however expedient that the recess 25 extends only over a part region of the pipe sleeve 15, so that a bar is left at least at the end of the pipe sleeve 15, wherein the bar is designed to be deepened preferably such that jamming-free removal of the template 19 is possible after application of peripheral embossing 12.

The recess 25 of the pipe sleeve 15, the longitudinally axial depression 24 and the recess 23 of the contact surface region are preferably arranged to be longitudinally axial to one another. As can be seen in FIG. 2, the recess 25, the longitudinally axial depression 24 and the recess 23 of the contact surface region are thus arranged to be aligned parallel to the longitudinal axis 18. However, it is also possible that the recess 25, the longitudinally axial depression 24 and the recess 23 are not arranged parallel to the longitudinal axis 18, but are arranged running inclined at an angle with respect to the longitudinal axis 18. In this case, they run along a screw line running around the pipe sleeve 15, the pitch of which depends essentially on the size of the angle with respect to the longitudinal axis 18. After embossing or stamping of peripheral embossing 12 by means of the stamping tool 11, the pipe sleeve 15 may be withdrawn from the pipe end section 13 by simultaneous rotation about the longitudinal axis 18.

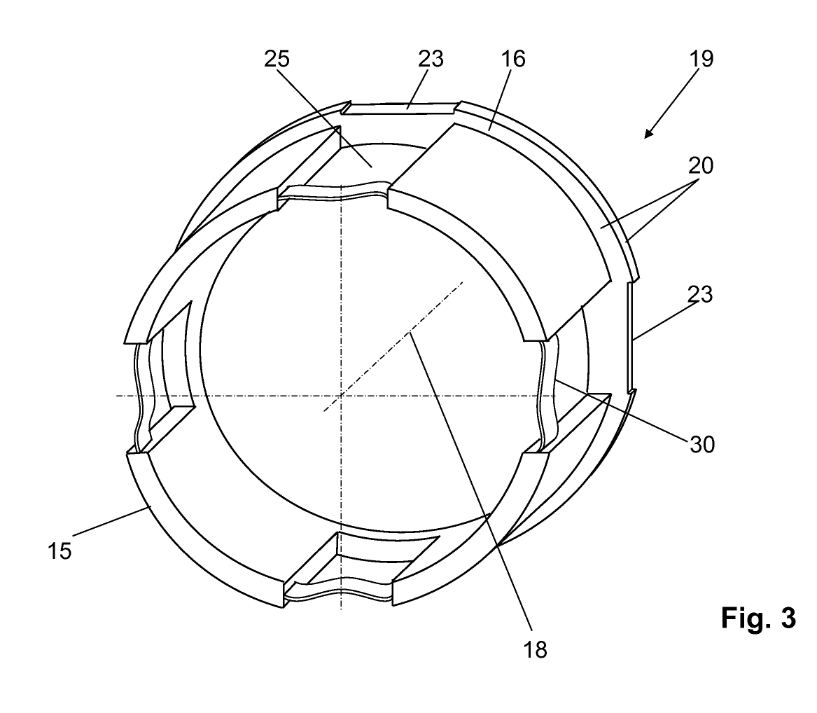

According to a particularly advantageous development of the invention, the pipe sleeve 15 has several recesses 25, longitudinally axial depressions 24 and/or recesses 23 of the contact surface region 16. They are each preferably arranged to be symmetrical with respect to the longitudinal axis 18 of the pipe 14. FIGS. 2 and 3 show by way of example a pipe sleeve 15 of the invention, which has in total four recesses 25, four depressions 24 and four recesses 23. Of course the number is not restricted to four, but can be selected freely.

According to a further advantageous design of the invention, the stamping tool counter-surface 20 is designed to correspond to a contact surface 28 of the stamping tool 11, so that the stamping tool counter-surface 20 rests as flatly as possible against the contact surface 28. The stamping tool counter-surface 20 and the contact surface 28 may be designed of course not only, as shown in FIG. 1, in each case as a flat surface, but optionally may also comprise further shapes, provided they are equipped to correspond to one another. For example the contact surface 28 of the stamping tool 11 may be designed as a recess, into which the stamping tool counter-surface 20 engages in positive-locking manner.

FIG. 3 shows a perspective view of a second preferred embodiment of the invention. The second embodiment shown in FIG. 3 corresponds essentially to the previously described preferred embodiment of the invention, but with the difference that a spring element 30 is arranged in at least one of the recesses 25. The spring element 30 is preferably designed as a spring steel or alternatively made from any other material having spring action. At least one of the spring elements 30 is preferably arranged in any of the general recesses 25, so that they exert a corresponding ring tension on the sections of the pipe sleeve 15 remaining between the recesses 25 and they press the said sections of the pipe sleeve 15 radially outwards. In this manner a clamping force, which fixes the template 19 in the pipe end section 13 to a certain extent, is produced between the said sections of the pipe sleeve 15 and the pipe wall 21. After processing of the pipe wall 21 by means of the stamping tool 11, the template 19 may be removed without problems again from the pipe end section 13. Recesses 25 are preferably designed to be continuous.

The pipe sleeve 15, starting from the contact surface region 16, is particularly preferably designed to be slightly conically widened and optionally bevelled at the end of the pipe sleeve 15. The bevelling serves for simpler ease of introduction of the pipe sleeve 15 into the pipe end section 13, whereas the conical widening leads to the pipe sleeve 15 being able to be compressed to a certain extent during introduction into the pipe end section 13 and the said ring tension being able to be set up by means of the spring elements 30.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A pipe processing apparatus comprising:
a stamping tool for applying one or more of peripheral embossing and peripheral stamping to a pipe end section of a pipe; and
a template which has a pipe sleeve which can be inserted in the pipe end section and having at least one contact surface region, wherein the at least one contact surface region is designed and equipped to limit the insertion depth of the pipe sleeve by means of positive locking between the contact surface region and at least one part region of a pipe end of the pipe end section facing the contact surface region and to position the stamping tool in a work position on the pipe end section as a stamping tool counter-surface.

2. An apparatus according to claim 1, characterised in that the contact surface region is arranged to surround the pipe sleeve.

3. An apparatus according to claim 1, characterised in that the contact surface region has at least one recess which is designed and equipped for positive-locking lateral reception and guiding of the stamping tool.

4. An apparatus according to claim 1, characterised in that the pipe sleeve has at least one longitudinally axial depression which is equipped to form a reception space between the pipe sleeve and a pipe wall of the pipe end section along at least one part section of the pipe sleeve.

5. An apparatus according to claim 1, characterised in that the pipe sleeve has at least one recess which is equipped and arranged such that the pipe sleeve can be fitted unhindered by at least one of a stamp and/or a die of the stamping tool in the work position for application of peripheral embossing or peripheral stamping.

6. An apparatus according to claim 3, characterised in that the recess of the pipe sleeve, the longitudinally axial depression and the recess of the contact surface region are arranged at least essentially to be longitudinally axial to one another.

7. An apparatus according to claim 5, characterised in that the pipe sleeve has several of at least one of recesses and longitudinally axial depressions that are each arranged to be symmetrical with respect to a longitudinal axis of the pipe.

8. An apparatus according to claim 5, characterized in that the contact surface region of the pipe sleeve has at least one of recesses of the contact surface region.

9. An apparatus according to claim 7, characterised in that a spring element is arranged in at least one of the recesses.

10. An apparatus according to claim 1, characterised in that the stamping tool counter-surface is designed to correspond to a contact surface of the stamping tool.
